(19) United States
(12) Patent Application Publication
(10) Pub. No.: US 2025/0269890 A1
(43) Pub. Date: Aug. 28, 2025

(54) Modular Cart System and Method

(71) Applicant: Micronova Manufacturing Inc., Torrance, CA (US)

(72) Inventors: Kristin Stewart, Harbor City, CA (US); Lorena Martinez, Downey, CA (US); Pennelope Davis, Torrance, CA (US)

(73) Assignee: Micronova Manufacturing Inc., Torrance, CA (US)

(21) Appl. No.: 19/001,110

(22) Filed: Dec. 24, 2024

Related U.S. Application Data
(60) Provisional application No. 63/616,765, filed on Dec. 31, 2023.

(51) Int. Cl. B62B 3/02; B62B 3/10; B62B 5/04; G08C 17/02

(52) U.S. Cl. CPC B62B 3/02; B62B 3/104; B62B 5/04; B62B 2205/006; G08C 17/02

(57) ABSTRACT

The present invention provides a modular cleaning cart system designed for controlled environments such as cleanrooms and pharmaceutical facilities. This system features a frame constructed from electropolished stainless steel, equipped with interchangeable joiner tubes for customizable dimensions to suit various cleaning tasks. The cart incorporates adjustable bucket hanger bars, modular side rails, and a wheel assembly with antimicrobial wheels and a foot-operated brake for enhanced maneuverability and stability. It includes telescopic handles, UV-C sterilization strips, and antimicrobial coatings for contamination resistance and ergonomic use. The system supports two-bucket or three-bucket configurations and integrates advanced features such as IoT-enabled sensors and alignment systems, offering an adaptable, efficient, and contamination-resistant solution for demanding cleaning requirements.

### CROSS-REFERENCE TO RELATED APPLICATIONS

This application claims priority from U.S. Provisional Patent Application Ser. No. 63/616,765, entitled “Adaptable Modular Cart for Controlled Environment,” and filed on Dec. 31, 2023, which is hereby incorporated by reference.

### BACKGROUND OF THE INVENTION

Cleaning in controlled environments, such as cleanrooms, pharmaceutical manufacturing facilities, and industrial settings, presents unique challenges. These environments demand stringent contamination control, ease of sanitation, and operational adaptability to accommodate diverse cleaning requirements. Existing cleaning carts often fall short of these requirements, lacking the versatility, ergonomic design, and contamination-resistant features needed for such applications.

Traditional cleaning carts are frequently limited in their configurability. They are typically designed for specific tasks, such as wet mopping, and often cannot be easily adapted to handle different cleaning setups, such as transitioning between single-bucket and multi-bucket systems. This lack of adaptability can lead to inefficiencies and increased time spent on reconfiguring or using multiple carts for different tasks.

Additionally, the materials used in many traditional carts are not optimized for controlled environments. Common materials may lack the necessary resistance to corrosion or the ability to withstand autoclaving and other sterilization methods required for maintaining hygiene standards in cleanrooms. Furthermore, traditional carts may lack features such as antimicrobial components or systems to minimize microbial growth, which are critical in environments where contamination control is paramount.

Another issue with traditional carts is their limited ergonomic and safety features. Users often experience physical strain due to poor handle placement, inadequate bucket heights, and limited maneuverability, particularly when moving carts in tight or crowded spaces. Vibration during movement and instability on uneven surfaces can further exacerbate these issues, leading to inefficiencies and potential safety hazards.

The current state of the art also lacks effective systems for integrating modern technological features, such as optional IoT-enabled monitoring, UV-C sterilization, or alignment sensors for precise bucket placement. These technologies could significantly enhance operational efficiency and contamination control but remain underutilized in existing designs.

In light of these challenges, there is a clear need for an advanced cleaning cart system that addresses these shortcomings. A modular cleaning cart system, capable of adapting to varying cleaning tasks, constructed from durable and autoclavable materials, equipped with ergonomic features, and enhanced with contamination-resistant and technological advancements, would provide a superior solution for controlled environments. The present invention aims to fulfill this need by introducing a versatile, innovative cleaning cart system designed specifically for the demanding requirements of controlled environments.

### SUMMARY OF THE INVENTION

The present invention relates to a modular cleaning cart system designed for use in controlled environments. The cart features a frame constructed from electropolished stainless steel, with a handle end and a base end. Interchangeable joiner tubes connect the handle and base ends, enabling reconfiguration of the cart's dimensions to meet various cleaning requirements. Adjustable bucket hanger bars secure buckets under their lips, accommodating a range of bucket sizes and materials. A wheel assembly, including stainless steel casters with antimicrobial wheels and a foot-operated brake, provides enhanced maneuverability and stability.

In certain embodiments, the joiner tubes are telescoping, allowing for incremental adjustments in the cart's length. Additionally, self-locking connectors may be included to simplify assembly and disassembly. The adjustable bucket hanger bars can incorporate quick-release mechanisms for rapid bucket removal. Modular side rails may enable the cart to be configured as a double-bucket or triple-bucket system. To reduce vibrations during movement, the wheel assembly may include shock-absorbing materials. The cart can also be equipped with telescopic handles to accommodate users of varying heights, integrated carrying handles for ergonomic transport, and rear handle hollows for securing mop handles during transit.

The invention further includes a method for adapting the cart for different cleaning configurations. This method involves assembling the cart using interchangeable side rails to configure it as either a two-bucket or three-bucket system. Buckets are attached using adjustable hanger bars, and the cart's length is extended or collapsed using modular joiner tubes. Buckets are secured under their lips to prevent misalignment and sliding during operation. In some methods, magnetic supports are used to secure the buckets to the hanger bars. The side rails may also be detached and replaced to accommodate buckets of varying shapes and sizes. The foot-operated brake can stabilize the cart during bucket attachment, and modular tool mounts may be added to support cleaning tools. To minimize contamination risks, antimicrobial wheels can be utilized during operation. After use, the cart's frame can be collapsed into a compact configuration for storage, and accessory trays can be attached to organize cleaning supplies. Alignment sensors may assist in ensuring proper bucket placement, while IoT-enabled sensors can monitor cleaning times and generate maintenance alerts.

A modular cleaning cart system configured for contamination-resistant operation is also disclosed. This system includes an autoclavable frame with detachable components for sterilization. UV-C sterilization strips integrated into the frame provide continuous surface sanitation during use, while antimicrobial coatings are applied to the wheel assembly and accessory mounts to inhibit microbial growth. Modular tool mounts and accessory trays are included for organizing cleaning tools and supplies. In some embodiments, removable accessory trays with dividers are provided for enhanced organization. The UV-C sterilization strips may be powered by kinetic energy recovery wheels. Modular mounts can hold squeegees, brushes, and spray containers, and antimicrobial coatings may extend to all detachable components. For added stability, a vibration-dampening suspension system may be included. The frame can also be designed to fold into a compact configuration for storage, and padded grips may be added to the handle for ergonomic use. Modular tool mounts can be adjusted to accommodate tools of varying sizes, while an alignment system ensures bucket stability during movement. Antimicrobial coatings may use silver-ion technology for enhanced contamination resistance.

This invention offers a versatile, ergonomic, and contamination-resistant solution for cleaning in controlled environments, meeting diverse operational requirements with innovative features and configurations.

### BRIEF DESCRIPTION OF THE DRAWINGS

FIG. 1 Illustrates one embodiment of a modular cart.

FIG. 2 illustrates a two bucket embodiment.

FIG. 3 further illustrates the embodiment of FIG. 2.

FIG. 4 further illustrates the embodiment of FIG. 2.

FIG. 5 illustrates a three bucket embodiment.

FIG. 6 further illustrates the embodiment of FIG. 5.

FIG. 7 further illustrates the embodiment of FIG. 5.

FIG. 8 illustrates an embodiment in which buckets are supported under the lip of

the buckets, at the top, as well as different dimensions of buckets employed simultaneously.

FIG. 9 further illustrates the embodiment of FIG. 8.

FIG. 10 further illustrates the embodiment of FIG. 8.

FIG. 11 illustrates a brake unlock and slide system.

FIG. 12 illustrates a fixed wire embodiment.

FIG. 13 further illustrates the embodiment of FIG. 12.

FIG. 14 further illustrates the embodiment of FIG. 12.

FIG. 15 illustrates other possible variations.

FIG. 16 further illustrates the embodiments of FIG. 15.

FIG. 17 further illustrates the embodiments of FIG. 15.

FIG. 18 illustrates a dual handle embodiment that can be configured to accommodate any number of receptacles.

FIG. 19 further illustrates the embodiment of FIG. 18.

FIG. 20 illustrates a handle holder assembly that is modular and kitted to be additive to either or both sides of the cart.

FIG. 21 illustrates assembly of the embodiment of FIG. 20.

FIG. 22 further illustrates the assembly of FIG. 20.

### DETAILED DESCRIPTION OF A PREFERRED EMBODIMENT

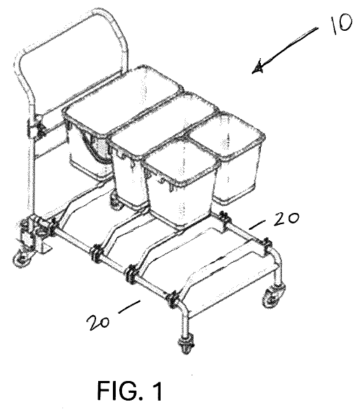

The present invention relates to a Modular Cart system designed to meet the diverse cleaning requirements of controlled environments such as cleanrooms, pharmaceutical manufacturing facilities, and industrial settings (see, e.g., FIG. 1). This cart 10 combines adaptability, ergonomic design, and advanced contamination resistance, providing a comprehensive and versatile solution to the challenges of traditional cleaning carts. The following detailed description outlines the key features and embodiments of the Modular Cart, including improvements and alternatives.

### Modular and Adaptable Design

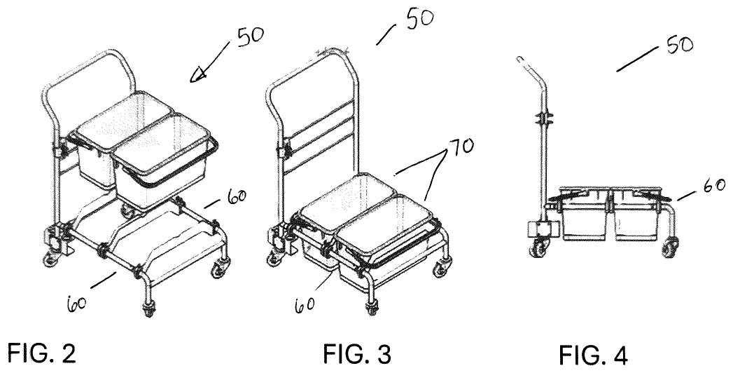

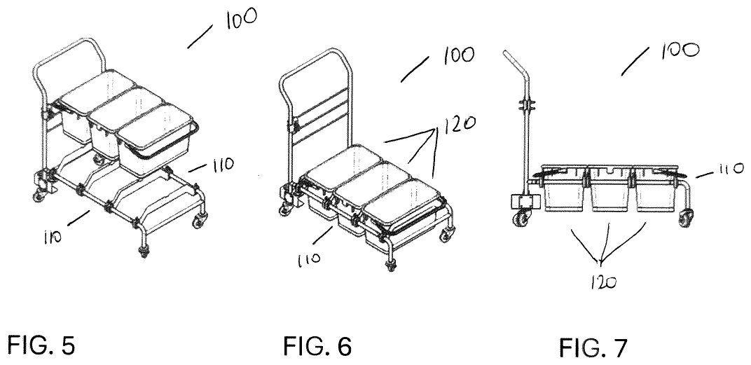

The Modular Cart features an innovative modular design that allows it to transform configurations to suit specific cleaning needs. The cart can have a common handle end and base end and, by changing the lengths of the joiner tubes, makes the length of the cart assembly customizable with minimal part change. The cart can be assembled as a compact two-bucket trolley 50 for use in small spaces (FIGS. 2-4), such as compounding rooms, or expanded into a three-bucket system 100 for larger, residue-intensive cleaning tasks (FIGS. 5-7). This adaptability is achieved through the use of interchangeable joiner tubes 20, 60, 110 that connect the handle end and the base end of the cart.

To enhance this modularity, the cart may include self-locking connectors that simplify assembly and disassembly processes, reducing setup time while ensuring secure connections. Additionally, optional telescoping joiner tubes with incremental length adjustments provide finer control over the cart's dimensions, enabling it to meet highly specific operational requirements.

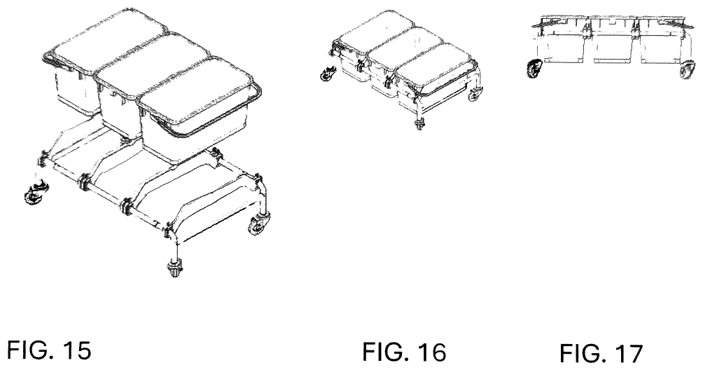

FIGS. 15-17, for example, illustrate a dual base adjustable to accommodate any number and style of receptacles. No handle assembly is shown.

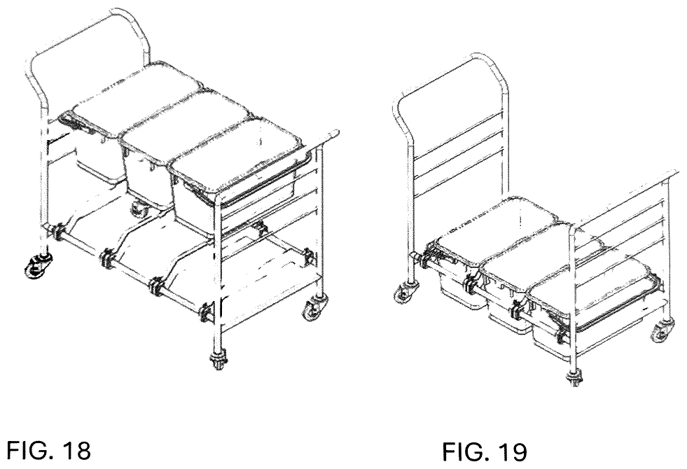

Another option is to provide two handles, one on each end (FIGS. 18-19). Again, by changing the length of the joiner tubes and/or adjusting the spacing of the sliding spacers, this provides a reconfigurable dual-handle system.

### Portability and Storability

The cart's lightweight frame, constructed from 304 electropolished stainless steel, enhances portability while maintaining structural integrity. The frame is disassemblable, allowing for compact storage and convenient transport. Optional screw-in casters further enhance the cart's adaptability by enabling reassembly in modified configurations as needed.

Alternative embodiments may include integrated carrying handles on detachable components for ergonomic transport. A collapsible frame or foldable storage design can also be implemented to reduce the cart's storage footprint, making it ideal for use in crowded facilities or during transport between locations.

### Contamination Resistance and Compliance

The Modular Cart is specifically designed to comply with Annex 1 contamination control standards, ensuring its suitability for cleanroom environments. The electropolished stainless steel construction provides a smooth, non-porous surface that resists corrosion and facilitates easy cleaning and decontamination. The cart's compatibility with autoclaving ensures high-temperature sterilization of all components, maintaining the stringent hygiene requirements of controlled environments.

To further enhance contamination resistance, the cart may include antimicrobial coatings on key components or UV-C sterilization strips integrated into the frame. These features inhibit microbial growth and continuously sanitize the cart's surfaces, reducing the need for frequent manual cleaning.

### Bucket Suspension System

The cart's bucket suspension system secures buckets 70, 120, 220 under the lip

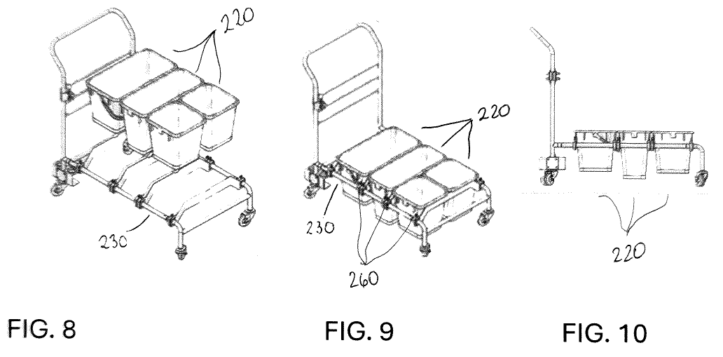

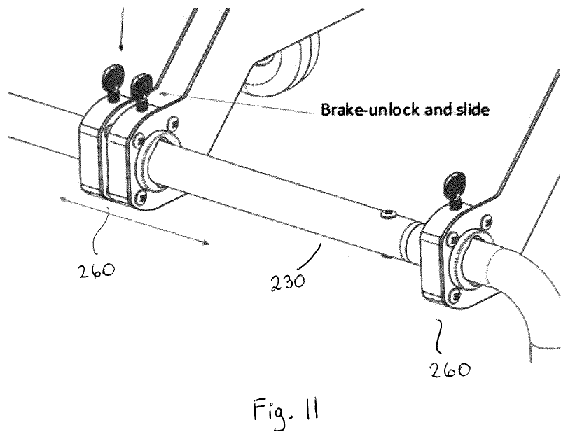

rather than at the base (see, e.g., FIGS. 3, 6, 9), using adjustable separators (e.g. Ref. No. 260 in FIGS. 9 & 11) and extension rods. This design prevents misalignment and sliding, accommodating buckets of various materials and sizes (see, e.g., FIGS. 9 & 10), including stainless steel and plastic. The system supports side-by-side configurations for increased flexibility (see. e.g., FIGS. 8 & 9). Supporting the bucket or receptacle under the lip at the top, rather than as commonly done at the bottom of the receptacle, allows for variations in the size, style, and other aspects of the receptacle, including depth. For example, as seen in FIGS. 8-11, options may include mixing in a narrower and taller bucket, using dual side-by-side buckets, and so forth.

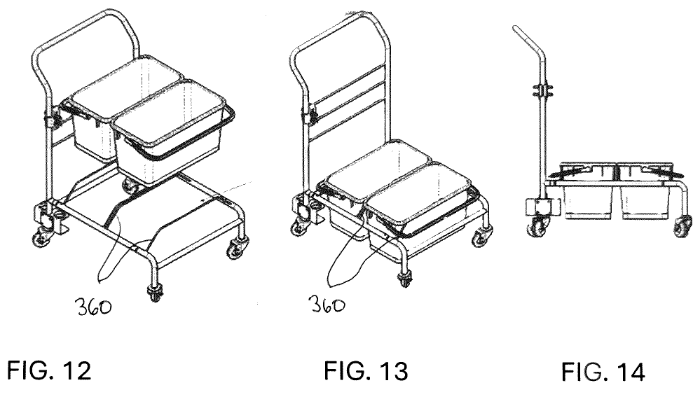

FIGS. 12-14 illustrates an alternative in which fixed wire supports 360 provide support for the rims. This is in contrast to other embodiments in which the supports are adjustable and can be moved along the length of the joiner tubes to adapt to the widths of the chosen receptacles. These adjustable embodiments are especially useful for changing needs in the field.

Alternative embodiments may optionally include magnetic bucket supports for effortless attachment and stability. A quick-release mechanism could also be added to enable rapid bucket changes during high-demand cleaning tasks. Optional sensors integrated into the suspension system can detect bucket misalignment and provide real-time alerts to prevent operational disruptions.

### Interchangeable Side Rails for Configurations

The Modular Cart includes interchangeable side rails 20, 60, 110, 230 that allow users to convert the cart into double or triple bucket systems. Adjustable bucket hanger bars accommodate various bucket shapes, including rectangular and shallow designs. This feature enables users to customize the cart for diverse cleaning scenarios, providing a significant advantage over standard cleaning carts.

### Advanced Maneuverability and Ergonomics

The cart is equipped with stainless steel casters and Prevenz™ antimicrobial wheels, ensuring smooth movement across various surfaces while inhibiting microbial growth. A foot-operated wheel brake system enhances safety and supports low-touch operation, minimizing contamination risks. The raised bucket height reduces the need for bending, improving user ergonomics and reducing physical strain during extended cleaning tasks.

Additional ergonomic improvements may include telescopic handles and padded grips to accommodate users of different heights and preferences. LED indicators on the brake system can also enhance visibility in low-light environments, ensuring safe and effective operation.

### Compatibility with Accessories and Tools

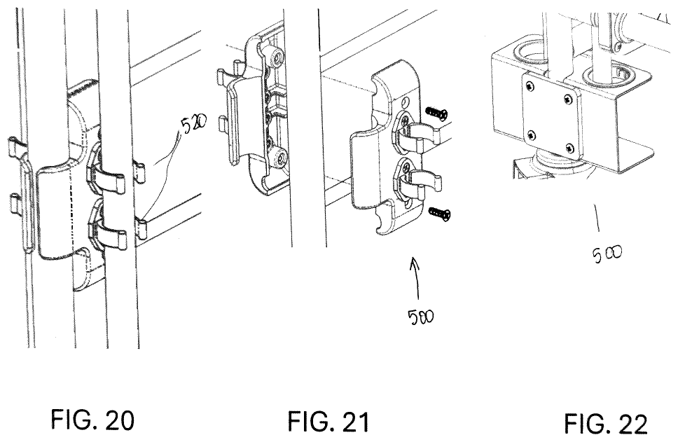

The Modular Cart is compatible with a variety of wringers and mops, including both stainless steel and plastic options. Optional components, such as stainless steel hanging baskets, mop handle clips (see, e.g., FIG. 20), and rear handle hollows, enhance its utility. Modular tool mounts may be added to support squeegees, brushes, and spray containers, further expanding the cart's versatility.

Removable accessory trays with dividers can also be integrated to organize smaller cleaning supplies, improving workflow efficiency and ensuring that all tools are easily accessible during cleaning tasks.

### Enhanced Stability and Safety

The cart's raised bucket height (see, e.g., FIG. 4) and hanging bucket design

enhance stability during operation, reducing the risk of spills and improving safety. The advanced wheel system, combined with the foot-operated brake, ensures the cart remains stationary during cleaning tasks.

For facilities requiring additional stability, the cart may be equipped with shock-absorbing suspension systems or vibration-dampening materials to ensure smooth operation even on uneven surfaces.

### Alternative Embodiments and Features

FIGS. 20-22 illustrate an optional handle holder assembly 500. This assembly may be modular and kitted. It can be added to either or both sides of the cart. As seen, the handle holder includes clips 520 to hold the handle of a mop or broom, for example.

To further enhance the cart's functionality, the following alternative embodiments are proposed. Sensors and IoT-enabled devices can track cleaning times, monitor component wear, and alert users when maintenance is required. Kinetic energy recovery systems may be integrated into the wheels to power optional electronic features. Sliding drawers with removable trays can supplement and/or replace hanging buckets, providing a more stable storage solution for waste and cleaning solutions.

### Example: How the Modular Cart Adapts to Normal Use

As one non-limiting example, to illustrate one embodiment of a method of use, the following is presented. The Modular Cart system is designed to seamlessly integrate into the day-to-day operations of cleaning professionals, offering adaptability, ease of use, and contamination resistance. The following scenario illustrates how the cart may be utilized in a typical workday within controlled environments, such as cleanrooms or pharmaceutical facilities, highlighting its modularity and user-friendly features.

### Morning: Preparing for Cleaning Tasks in a Controlled Environment

A cleaning technician begins their shift in a pharmaceutical manufacturing cleanroom, where both light cleaning in smaller compounding rooms and intensive cleaning in larger production areas are required later in the day.

### Initial Setup

The technician configures the cart as a compact two-bucket trolley to navigate narrow corridors. The interchangeable side rails secure two rectangular stainless steel buckets, while adjustable bucket hanger bars ensure proper alignment. A mop handle is attached to the cast-molded handle holder, and an accessory tray is clipped onto the cart for holding cleaning cloths and sanitizing agents.

### Portability and Use

The stainless steel casters with antimicrobial wheels ensure smooth movement across cleanroom floors, while the foot-operated wheel brake stabilizes the cart during cleaning. The raised bucket height minimizes bending, reducing physical strain during repetitive cleaning tasks.

### Midday: Reconfiguring for Deep Cleaning in the Production Facility

Following the initial tasks, the technician prepares the cart for deep cleaning in a larger production space. Using the modular joiner tubes, the technician changes the cart configuration. The cart's length is extended, transitioning it into a three-bucket system. A third bucket is added, secured with adjustable hanger bars repositioned to accommodate the new layout. The cart is equipped with a heavy-duty mop in the cast-molded handle holder, a wringer attachment, and additional tools such as a squeegee and spray container, mounted using the modular tool mounts.

### Stability and Safety

The foot-operated wheel brake ensures stability during the mixing of cleaning solutions. The hanging bucket design enhances stability during movement, even when the buckets are partially filled.

### Contamination Control

Between tasks, the UV-C sterilization strip integrated into the frame sanitizes surfaces, ensuring compliance with Annex 1 contamination standards. Prevenz™ antimicrobial wheels further reduce contamination risks as the cart transitions between areas.

### Afternoon: Cleaning Tool Maintenance and Transport

After completing the cleaning tasks, the technician prepares the cart for sterilization and storage. For sterilization, the cart is disassembled into its individual components, including the frame, buckets, and accessory trays. The stainless steel components are placed in an autoclave for high-temperature sterilization. Quick-release mechanisms allow for the rapid removal of buckets, saving time during this process.

After sterilization, the cart's frame is collapsed into a compact configuration for minimal storage space. Integrated carrying handles on detachable components make it easy to transport the disassembled parts to the storage area.

### Evening: Reassembly for Future Use

At the end of the day, the technician reassembles the cart in its compact two-bucket configuration, ensuring it is ready for use the next morning. The modular design allows for quick reconfiguration to adapt to the following day's cleaning requirements.

### Key Features Demonstrated in Normal Use

The daily use of the Modular Cart highlights several key features that, alone or in combination, make it well-suited for controlled environments. The system is adaptable in that it seamlessly transitions between configurations, such as two-bucket and three-bucket systems, for varying cleaning needs.

The system provides ease-of-use, with quick-release mechanisms, modular components, and ergonomic features streamline operation. It is contamination resistant as UV-C sterilization, antimicrobial wheels, and autoclavable parts maintain hygiene standards.

The system is ergonomic, with raised bucket heights, padded grips, and smooth caster movement reduce user strain. The system is also portable and storable, having a collapsible frame and lightweight components that allow for easy transport and compact storage.

### Variations and Modifications

Embodiments of the present invention may be adapted and enhanced through a range of possible variations and modifications that expand its functionality, improve user ergonomics, and augment its contamination-resistance capabilities. In certain embodiments, the cleaning cart can include advanced sensor integration for monitoring fluid levels, chemical concentrations, or cart location, thereby optimizing workflows and ensuring that cleanliness standards are consistently met. A smart compartment system may be introduced, utilizing lockable drawers or compartments with RFID scanning to manage tools, personal protective equipment, and consumables in real time. Some designs can further benefit from a built-in scale mechanism underneath each bucket, enabling precise measurements of both cleaning fluids and waste, and helping to regulate chemical usage and restocking schedules.

The invention can also be configured with a hybrid power module, such as a battery array or kinetic energy recovery wheels, to power digital features like LCD screens, UV-C sterilization strips, and sensor arrays. These capabilities can be coupled with automated sterilization alerts, which rely on usage data to remind operators when the cart requires autoclaving. In some instances, a folding handle mechanism may allow for even more compact storage, and color-coded side rails might be added to help personnel quickly identify the cart's configuration, whether operating in a two-bucket or three-bucket mode. Material improvements could include silver-ion antimicrobial coatings and shock-dampening caster designs, both of which reduce microbial growth and minimize vibration-related strain. Additional enhancements to the bucket hanger system, such as magnetic bucket supports or integrated sensors to detect misalignment, can further streamline operations, as can a quick-mount rail system with spring-loaded latches that allows easy swapping of side rails without tools.

To better accommodate user comfort, optional telescopic handles and pivot-assist steering features can reduce physical strain, especially in large or congested facilities. Further ergonomic refinements can include padded handle grips, raised bucket supports, and tilt sensors that detect when the cart is nearing an unstable angle. Accessory mounts may be equipped with RFID scanning and tool management features, helping to maintain proper inventory control. Alternative embodiments can include drawer configurations that supplement or replace certain buckets, offering a secure and stable system for storing waste or cleaning solutions. Collectively, these modifications provide robust flexibility for a variety of applications, ensuring the cart remains adaptable to evolving cleaning standards and operational demands in controlled environments.

1-30. (canceled)

31. A method of reconfiguring a modular clean-room cart, the method comprising: (a) detaching at least one first joiner tube that spans between a handle end and a base end of a frame of the cart; (b) attaching at least one second joiner tube of a different length to thereby change an overall length of the frame; (c) repositioning one or more bucket supports carried by the frame to define at least one bucket station; and (d) hanging at least one bucket from the bucket supports by engaging a rim of the bucket beneath the bucket supports so that a bottom of the bucket is suspended above a floor.

32. The method of claim 31, wherein step (c) positions the bucket supports to provide a user-selected configuration that accommodates one, two, or three buckets.

33. The method of claim 31, wherein steps (a) and (b) are performed without hand tools by releasing and engaging quick-disconnect couplings.

34. The method of claim 31, wherein the bucket supports comprise under-lip hanger bars that contact undersides of bucket rims.

35. The method of claim 31, further comprising, after step (d), disassembling at least the frame and bucket supports and autoclaving the disassembled parts.

36. The method of claim 31, further comprising engaging a foot-operated antimicrobial brake assembly to immobilize the cart.

37. The method of claim 31, further comprising powering UV-C illumination strips mounted to the frame.

38. The method of claim 37, wherein the UV-C illumination strips are powered by electrical energy harvested from rotation of a wheel of the cart.

39. The method of claim 31, further comprising attaching at least one Internet-of-Things sensor to the frame.

40. The method of claim 39, further comprising transmitting data generated by the sensor wirelessly to a cloud-based audit trail.

41. The method of claim 31, wherein steps (c) and (d) include suspending first and second buckets side-by-side from a same pair of the bucket supports.

42. The method of claim 41, wherein the first bucket has a depth different from the second bucket.

43. A method of configuring a sterilizable cart for clean-room mopping operations, the method comprising: (a) releasing a quick-disconnect coupling to remove a first joiner tube bridging a handle module and a base module of the cart; (b) inserting a second joiner tube having a length selected from a set consisting of short, medium, and long tubes so as to establish a short, medium, or long frame length; (c) sliding first and second under-lip hanger bars along opposed side rails of the frame to spaced-apart positions that define two bucket stations; and (d) suspending two mopping-solution buckets from the hanger bars solely by engagement of the hanger bars with undersides of rims of the buckets.

44. The method of claim 43, further comprising sliding a third under-lip hanger bar to create a third bucket station and suspending a rinse bucket therefrom.

45. The method of claim 43, further comprising disassembling the cart after step (d) and autoclaving the handle module, base module, second joiner tube, hanger bars, and buckets at 121° C. for at least 20 minutes.

46. The method of claim 43, further comprising engaging a wheel brake that includes silver-ion antimicrobial components.

47. The method of claim 43, wherein the hanger bars lock into detent positions spaced in equal increments along the side rails.

48. A method of converting a modular clean-room cart from a two-bucket configuration to a three-bucket, sensor-enabled, UV-sterilizing configuration, the method comprising, in the following order: (i) unlocking and removing a medium-length joiner tube from between a handle assembly and a caster assembly of the cart; (ii) installing a long joiner tube to increase a wheelbase of the cart; (iii) mounting a UV-C irradiation strip to an underside of the long joiner tube and electrically connecting the strip to a kinetic-energy power module coupled to at least one wheel; (iv) sliding three under-lip hanger bars along opposed side rails of the cart to positions that divide a longitudinal span of the frame into three substantially equal bucket bays; (v) hanging first, second, and third buckets respectively in the bucket bays by engaging the hanger bars beneath rims of the buckets such that bottoms of the buckets are suspended above a floor; (vi) attaching a wireless fluid-level sensor to at least one of the buckets; and (vii) actuating an antimicrobial foot brake to lock the wheels.

49. The method of claim 48, further comprising transmitting fluid-level data generated by the sensor to a cloud-based quality-assurance system.

50. The method of claim 48, wherein the first and second buckets are suspended side-by-side from a common pair of the under-lip hanger bars, the first bucket having a depth different from the second bucket.
